(19) United States
(12) Patent Application Publication
(10) Pub. No.: US 2013/0142684 A1
(43) Pub. Date: Jun. 6, 2013

(54) CHECK VALVE AND SOLVENT DELIVERY PUMP

(71) Applicant: Yoshiaki Asou, Kyoto (JP)

(72) Inventor: Yoshiaki Asou, Kyoto (JP)

(73) Assignee: SHIMADZU CORPORATION, Kyoto (JP)

(21) Appl. No.: 13/814,763

(22) PCT Filed: Aug. 20, 2010
(86) PCT No.: PCT/JP2010/064045

§ 371 Date: Feb. 7, 2013

(51) Int. Cl. F04B 53/10

(52) U.S. Cl. CPC F04B 53/1002
USPC 417/559; 137/511

(57) ABSTRACT

A valve chamber is provided inside a valve element including a liquid inlet and a liquid outlet at positions facing each other. Inside the valve chamber, a ball is disposed to be movable in a direction of a straight line connecting the liquid inlet and the liquid outlet. A ball seat is fitted in the liquid inlet portion of the valve element. The ball seat includes a flow path forming the liquid inlet inside itself and allows the ball to be seated at an edge portion of the flow path. The ball seat is made of material having a hexagonal crystal structure and formed while controlling an orientation of a crystal axis so that a C axis which is the crystal axis of the material is oriented in the same direction as a central axis of the flow path forming the liquid inlet.

### TECHNICAL FIELD

The present invention relates to a check valve for closing a flow path by allowing a ball to be seated on a ball seat and for opening the flow path by floating the ball from the ball seat and to a solvent delivery pump employing the check valve.

### BACKGROUND ART

Employed in general as a solvent delivery pump for sending a mobile phase to an analytical flow path of a high-speed liquid chromatograph, for example, is a plunger pump in which a plunger reciprocates in a straight line in a pump chamber formed in a pump head to increase and decrease a capacity in the pump chamber to thereby take solution into the pump chamber and discharge the solution from the pump chamber. In such a solvent delivery pump, check valves are respectively provided in flow paths connected to a sucking port and a discharge port of the pump chamber, and the check valve on a side of the sucking port is opened and the check valve on a side of the discharge port is closed in sucking the solution while the check valve on the side of the discharge port is opened and the check valve on the side of the sucking port is closed in discharging the solution (see Patent Document 1, for example).

The check valve includes a valve chamber in a valve element having a liquid inlet and a liquid outlet at positions facing each other, and a ball is disposed to be movable in the valve chamber in a straight line connecting the liquid inlet and the liquid outlet. A cylindrical ball seat on which the ball is to be seated is provided at a liquid inlet portion of the valve element. The ball seat is, for example, in a cylindrical shape and includes, inside itself, a flow path forming the liquid inlet, and the ball is seated on the ball seat to thereby seal the flow path. In such a check valve, in general, ruby is mainly used as material of the ball, and sapphire is mainly used as material of the ball seat.

Patent Document 1: Japanese Patent Application Laid-Open No. 2008-180088

### DISCLOSURE OF THE INVENTION

### Problem to be Solved by the Invention

If solution sending pressure is a high pressure over, for example, 50 MPa in a high-speed liquid chromatograph or the like, the ball of the check valve on the closed side is pushed against the ball seat by a strong force and, therefore, a portion of the ball seat which comes in contact with the ball needs to have enough strength to withstand the pressure. However, the strength varies between the respective ball seats, and the strength of the arc-shaped portion which comes in contact with the ball is not uniform in many cases. Therefore, when the ball is seated, stress is concentrated on a portion of the ball seat having the lowest mechanical strength to chip or crack the portion to thereby break the ball seat. Especially when the solution sending pressure is a high pressure over, for example, 50 MPa, the ball seat may be broken.

It is therefore an object of the present invention to provide a check valve having a ball seat which is less likely to be broken even under high-pressure solution sending conditions and a solvent delivery pump having the check valve.

### Means for Solving the Problem

A check valve to which the present invention is applied includes: a valve element including a liquid inlet and a liquid outlet at positions facing each other; a valve chamber provided inside the valve element and between the liquid inlet and the liquid outlet; a ball for moving toward the liquid outlet when pressure is higher on a side of the liquid inlet than on a side of the liquid outlet and for moving toward the liquid inlet when the pressure is higher on the side of the liquid outlet than on the side of the liquid inlet in the valve chamber; and a ball seat disposed at a liquid inlet portion of the valve element and including, inside itself, a flow path, which has a smaller diameter than the ball and forms the liquid inlet, to allow the ball to be seated at an edge portion of the flow path to seal the flow path when the ball moves toward the liquid inlet.

Normally, to form a shape of the ball seat, a workpiece of a required size is cut out of the sapphire base material and worked into a required shape. The sapphire has a hexagonal crystal structure and is merely worked into a shape of a ball seat without consideration of a crystal axis orientation of the hexagonal crystal in prior-art ball seat working. The present inventor found that this working method causes variations in strength of the ball seat and achieved the present invention.

In other words, the hexagonal crystal structure has three plane directions which are called C plane, A plane, and R plane, respectively. The axis perpendicular to the C plane is a C axis and an orientation of the C axis is different between prior-art ball seats. Therefore, mechanical strength varies between the respective ball seats, and the mechanical strength of a portion which comes in contact with the ball is not uniform depending on the orientation of the C axis.

Therefore, in the check valve according to the present invention, the ball seat is made of material having the hexagonal crystal structure, and the C axis which is the crystal axis of the material is oriented in a direction parallel to a central axis passing through a center of the flow path. By forming the ball seat while controlling the orientation of the crystal axis so that the C axis is oriented in the direction parallel to the central axis, the entire portion to be in contact with the ball is on the C plane of the hexagonal crystal and the mechanical strength of the portion to be in contact with the ball becomes uniform.

A solvent delivery pump according to the present invention includes: a pump chamber including a sucking port for sucking solution and a discharge port for discharging the solution; a plunger inserted into the pump chamber to reciprocate in a straight line to increase and decrease a capacity in the pump chamber; and the check valve according to the present invention and disposed in at least one of a flow path connected to the sucking port of the plunger and a flow path connected to the discharge port.

### Effects of the Invention

In the check valve according to the present invention, because the C axis, which is the crystal axis of the ball seat made of the material having the hexagonal crystal structure, is oriented in the direction parallel to the central axis passing through the center of the flow path in the ball seat, the entire portion to be in contact with the ball can be disposed on the C plane of the hexagonal crystal, and the mechanical strength of the portion to be in contact with the ball becomes uniform. As a result, stress is not concentrated on one portion of the portion of the ball seat to be in contact with the ball, and it is possible to stably provide the check valve having the ball seat which is less likely to be broken even under high pressure.

In the solvent delivery pump according to the present invention, the check valve according to the present invention is used as each of the check valves provided in the flow path connected to the sucking port of the pump chamber and the flow path connected to the discharge port and, therefore, the ball seat of the check valve is less likely to be broken even when the solution sending pressure is high and it is possible to stably send the solution under high-pressure conditions.

An example of use of the solvent delivery pump according to the present invention is a liquid chromatograph. In the liquid chromatograph, a sample injecting portion, an analytical column, and a detector are disposed on an analytical flow path through which a mobile phase is sent by a solvent delivery pump. If the solvent delivery pump according to the present invention is used as the solvent delivery pump, the life is extended even if the mobile phase is sent under the high-pressure conditions.

### BRIEF DESCRIPTION OF THE DRAWINGS

FIG. 1 is a sectional view showing an embodiment of a solvent delivery pump.

FIG. 2A is a sectional view showing a closed state of a check valve in the embodiment.

FIG. 2B is a sectional view showing an open state of the check valve in the embodiment.

FIG. 2C is a perspective view of a ball seat of the check valve in the embodiment.

FIG. 3 is a conceptual diagram for explaining a hexagonal crystal structure.

FIG. 4 is a diagram showing distributions of strength of a portion to be in contact with a ball when an orientation of a C axis is controlled to be in a direction of a central axis of a liquid inlet of the ball seat and when the orientation of the C axis is not controlled.

FIG. 5 is a flow path block diagram schematically showing an example of a liquid chromatograph.

### MODE FOR CARRYING OUT THE INVENTION

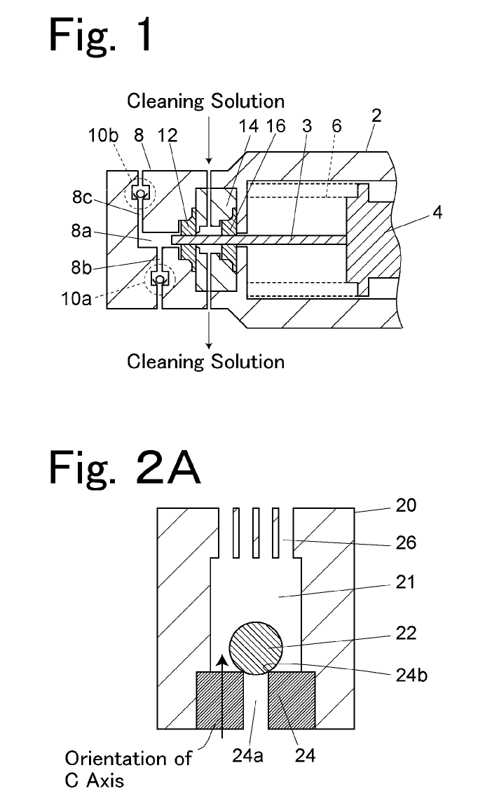

An embodiment of a solvent delivery pump will be described by using FIG. 1.

The solvent delivery pump in the embodiment includes a pump body 2 and a pump head 8. The pump body 2 includes a cam (not shown), which is driven by a motor (not shown), and houses, inside itself, a crosshead 4 which is caused by an elastic force of a spring 6 to reciprocate following a peripheral face of the cam while retaining an end face of a base end of a plunger 3. The pump head 8 is mounted to the pump body 2 and includes a pump chamber 8a, a solution sucking flow path 8b, and a solution discharge flow path 8c to carry out sucking and discharge of solution by reciprocation of a tip end portion of the plunger 3 retained by the crosshead 4.

The tip end portion of the plunger 3 is inserted into the pump chamber 8a and reciprocates in a direction (rightward direction in the drawing) for sucking the solution from the solution sucking flow path 8b into the pump chamber 8a while expanding a space in the pump chamber 8a and a direction (leftward direction in the drawing) for pushing the solution in the pump chamber 8a out to the solution discharge flow path 8c while contracting the space in the pump chamber 8a as the crosshead 4 reciprocates.

A seal holder 14 is disposed between the pump body 2 and the pump head 8 and a plunger seal 12 is provided between the pump head 8 and the seal holder 14. The plunger seal 12 seals a portion of the pump chamber 8a, through which the plunger 3 is inserted, to prevent leakage of the solution from the pump chamber 8a while retaining the plunger 3 for sliding.

The seal holder 14 has a cavity portion inside itself and includes a flow path for supplying cleaning solution into the cavity portion and a flow path for discharging the cleaning solution. A cleaning seal 16 is sandwiched between the pump body 2 and the seal holder 14. The cleaning seal 16 seals a portion of the cavity portion in the seal holder 14 through which the plunger 3 is inserted to prevent leakage of the cleaning solution from the cavity portion while retaining the plunger 3 for sliding.

Provided in the solution sucking flow path 8b and the solution discharge flow path 8c are check valves 10a and 10b for opening and closing the flow paths 8b and 8c by utilizing changes in pressure in the pump chamber 8a to thereby prevent backflow.

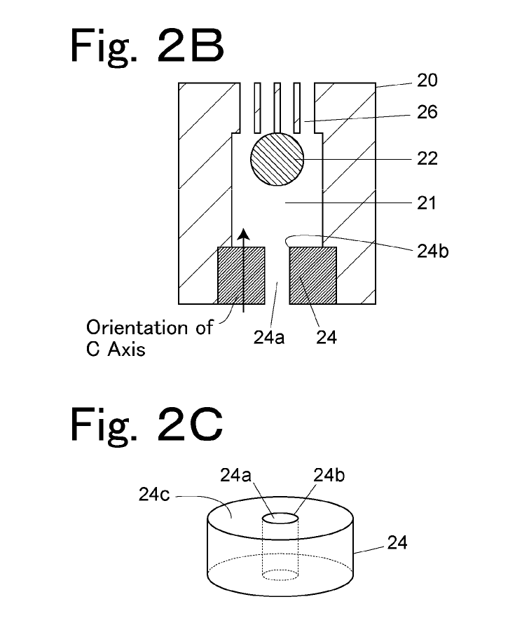

An example of structures of the check valves 10a and 10b is shown in FIG. 2A. The check valve 10a and the check valve 10b have the same structures. Each of the check valves 10a and 10b has a liquid outlet 26 at one end of a cylindrical valve element 20 through which a flow path passes and a ball seat 24 is fitted in the other end. A liquid inlet 24a is open in the ball seat 24. The liquid outlet 26 and the liquid inlet 24a communicate with each other through a valve chamber 21 at an intermediate position and having a larger diameter to form the flow path passing through the valve element 20. A ball 22 is provided in the valve chamber 21 to be movable in an axial direction of the cylinder and the ball 22, the ball seat 24, and the liquid outlet 26 are arranged in a straight line along the axial direction of the cylinder.

An inner diameter of the liquid inlet 24a formed by a cavity portion in the ball seat 24 is designed to be smaller than a diameter of the ball 22 and the ball 22 comes in contact with an edge of the cavity portion of the ball seat 24 to seal the liquid inlet 24a when the ball 22 is seated (see FIG. 2A). The ball 22 is made of, for example, ruby and the ball seat 24 is made of sapphire.

The liquid outlet 26 of the valve chamber 21 is formed by a plurality of through holes formed in a wall face having a larger diameter than the diameter of the ball 22, and the ball 22 does not close the liquid outlet 26 when the ball 22 floats and comes in contact with the wall face on a side of the liquid outlet 26 (see FIG. 2B). The ball 22 is seated on the ball seat 24 to seal the liquid inlet 24a when pressure becomes higher on the side of the liquid outlet 26 than on a side of the liquid inlet 24a while the ball 22 floats to open the liquid inlet 24a when the pressure becomes higher on the side of the liquid inlet 24a than on the side of the liquid outlet 26. In other words, when the plunger 3 is driven toward a discharge side (leftward in FIG. 1), an inside of the pump chamber 8a is pressurized and the pressure in the pump chamber 8a increases to close the check valve 10a and open the check valve 10b. On the other hand, when the plunger 3 is driven toward a sucking side (rightward in FIG. 1), the pressure in the pump chamber 8a is reduced to open the check valve 10a and close the check valve 10b.

In each of the check valves 10a and 10b in the closed state, the ball 22 is pushed against an edge portion of the liquid inlet 24a of the ball seat 24. Especially in the check valve 10a, solution sending pressure in the pump chamber 8a is applied on the ball 22 and, therefore, a portion of the ball seat 24 which comes in contact with the ball 22 needs to have enough mechanical strength to withstand the pressure.

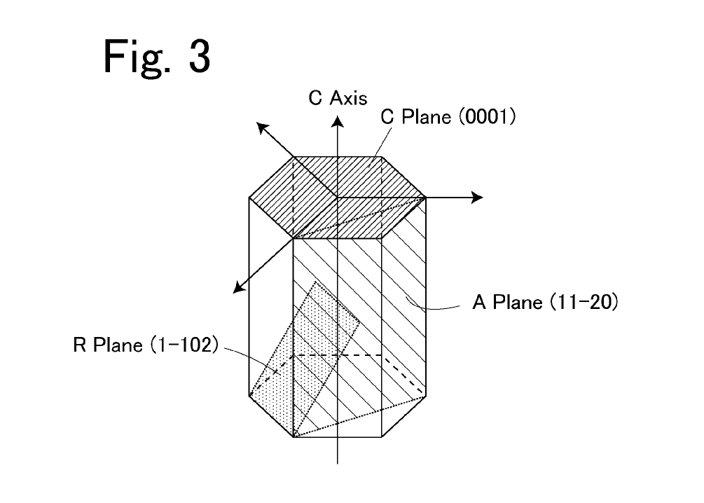

Therefore, as shown by arrows in FIGS. 2A and 2B, the ball seat 24 is worked by determining orientations of crystal axes so that C axis which is the crystal axis is oriented in the same direction as a central axis of the liquid inlet 24a of the ball seat 24, i.e., oriented vertically upward in FIGS. 2A and 2B. As shown in FIG. 3, the C axis is an axis perpendicular to a C plane out of three plane directions, i.e., C plane, A plane, and R plane of a hexagonal crystal structure. Such a ball seat 24 is formed by working a C-plane ingot of sapphire crystallized by, for example, a Kyropoulos method based on the C plane as a reference plane. In the ball seat 24 formed in this manner, as shown in FIG. 2C, a face 24c having an edge portion 24b of the liquid inlet 24a to be in contact with the ball 22 when the ball 22 is seated is the C plane of the hexagonal crystal structure and, therefore, mechanical strength of the portion 24b to be in contact with the ball 22 is uniform.

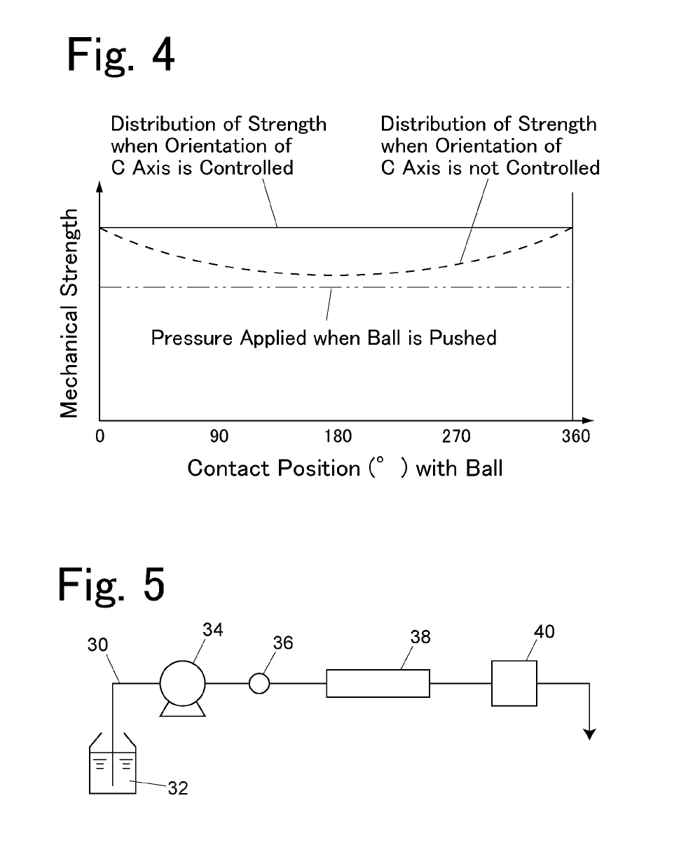

FIG. 4 shows examples of distributions of strength of the portion in contact with the ball 22 when the orientation of the C axis is controlled to be in the direction of the central axis of the liquid inlet 24a of the ball seat 24 and when the orientation of the C axis is not controlled. A horizontal axis represents angles of an opening portion of the cylindrical ball seat, i.e., an entire circumference of the portion of the ball on which the ball is seated. A vertical axis represents the mechanical strength. If the orientation of the C axis is not controlled (a broken line), the mechanical strength of the portion of the ball seat 24 to be in contact with the ball 22 is not uniform. When pressure applied when the ball 22 is pushed increases and if there is a portion having lower mechanical strength than the pressure, stress is concentrated on the portion having the low mechanical strength to chip or crack the portion to thereby cause breakage of the ball seat 24. On the other hand, as shown by a straight line in a solid line, if the orientation of the C axis is controlled to be in the direction of the central axis of the liquid inlet 24a of the ball seat 24, the entire face of the ball seat 24 in contact with the ball 22 becomes the C plane and, therefore, the mechanical strength of the portion of the ball seat 24 to be in contact with the ball 22 becomes uniform.

Table 1 shows experimental data when comparison of strength between the ball seat worked while controlling the orientation of the C axis and the ball seat formed without controlling the orientation of the C axis (in a random fashion) was carried out. In Table 1, “C axis” “Controlled” refers to the case in which the ball seat formed while controlling the orientation of the C axis to be in the same direction as the central axis is used and “C axis” “Uncontrolled” refers to the case in which the ball seat formed without consideration of the orientation of the C axis is used, respectively. In this experiment, the ball was seated on the ball seat, the ball and the ball seat were pushed against each other, compressive strength was gradually increased, and the compressive strength when the ball seat was broken was measured. In this measurement, the ball seat of an inner diameter of 1.0 mm, an outside shape of 2.35 mm, and the ball with a diameter of 1.5 mm were used.

TABLE 1

| | Compressive | Object to |
|---|---|---|
| C axis | strength (kN) | be broken |
| Uncontrolled | 0.215 | Ball seat |
| Uncontrolled | 0.307 | Ball seat |
| Uncontrolled | 0.344 | Ball seat |
| Uncontrolled | 0.319 | Ball seat |
| Uncontrolled | 0.293 | Ball seat |
| Controlled | 1.015 | Ball seat |
| Controlled | 1.020 | Ball seat |
| Controlled | 0.775 | Ball seat |
| Controlled | 1.018 | Ball seat |
| Controlled | 1.020 | Ball seat |
| Controlled | 1.019 | Ball seat |

As is clear from Table 1, when the C axis was “uncontrolled”, the compressive strength was as low as 0.215 to 0.344 (kN) when the ball seat was broken. On the other hand, when the C axis was “controlled”, the compressive strength was as high as 0.775 to 1.020 (kN). This shows that the ball seat having the uniform mechanical strength at the portion to be in contact with the ball can be formed stably by controlling the C axis.

Although the embodiment in FIG. 1 is the single-plunger solvent delivery pump for sending the solution with the single plunger pump, the present invention can be applied to a double-plunger solvent delivery pump as well. In the double-plunger solvent delivery pump, two plunger pumps may be connected in series or parallel.

In the solvent delivery pump in which the two plunger pumps are connected in series, a discharge port of the preceding plunger pump and a sucking portion of the subsequent plunger pump are connected in series, and the check valves are respectively provided between the discharge port of the preceding plunger pump and the sucking portion of the subsequent plunger pump and to a sucking portion of the preceding plunger pump. The ball seat of at least one of the check valves and especially the check valve at the sucking port of the preceding plunger pump on which high pressure is likely to be applied is the ball seat which is made of sapphire and the orientation of the C axis of which is controlled.

The preceding plunger pump has a larger pump chamber capacity than the subsequent plunger pump. While the preceding plunger pump is discharging the solution, the subsequent plunger pump is driven to take in some of the solution discharged from the preceding plunger pump. On the other hand, while the preceding plunger pump is sucking the solution, the subsequent plunger pump is driven to discharge the solution.

In the double-plunger solvent delivery pump in which the two plunger pumps are connected in parallel, the check valves are provided to sucking ports and discharge ports of the respective pump chambers and the ball seats of at least the check valves at the sucking ports of the respective plunger pumps are the ball seats which are made of sapphire and the orientations of the C axes of which are controlled.

Next, an example of a liquid chromatograph will be described by using FIG. 5.

On an analytical flow path 30 for sending a mobile phase 32, a solvent delivery pump 34, a sample injecting portion 36, an analytical column 38, and a detector 40 are disposed in this order from an upstream side. As the solvent delivery pump 34, the solvent delivery pump shown in FIG. 1 is used. The sample injecting portion 36 is provided to introduce a sample into the analytical flow path 30, and the sample injected at the sample injecting portion 36 is led to the analytical column 38 by the mobile phase 32 sent by the solvent delivery pump 34. The analytical column 38 is for separating the sample into respective components, and the respective components separated by the analytical column 38 are led to and detected by the detector 40. Because the solvent delivery pump using the check valve in which the ball seat as the ball seat is formed while controlling the orientation of the C axis is used as the solvent delivery pump 34, the check valve for preventing the backflow of the sent solution is less likely to be broken, and it is possible to stably send the solution even if the solution sending pressure is the high pressure over, for example, 50 MPa.

### EXPLANATION OF REFERENCE NUMERALS

2 pump body
3 plunger
4 crosshead
6 spring
8 pump head
10a, 10b check valve
12 plunger seal
14 seal holder
16 cleaning seal
20 valve chamber
22 ball
24 ball seat
24a liquid inlet
26 liquid outlet

1. A check valve comprising:
a valve element including a liquid inlet and a liquid outlet at positions facing each other;
a valve chamber provided inside the valve element and between the liquid inlet and the liquid outlet;
a ball for moving toward the liquid outlet when pressure is higher on a side of the liquid inlet than on a side of the liquid outlet and for moving toward the liquid inlet when the pressure is higher on the side of the liquid outlet than on the side of the liquid inlet in the valve chamber;
and a ball seat disposed at a liquid inlet portion of the valve element and including, inside itself, a flow path, which has a smaller diameter than the ball and forms the liquid inlet, to allow the ball to be seated at an edge portion of the flow path to seal the flow path when the ball moves toward the liquid inlet,
wherein the ball seat is made of material having a hexagonal crystal structure and a C axis which is a crystal axis of the material is oriented in a direction parallel to a central axis passing through a center of the flow path.

2. The check valve according to claim 1, wherein the material of the ball seat is sapphire.

3. A solvent delivery pump comprising:
a pump chamber including a sucking port for sucking solution and a discharge port for discharging the solution;
a plunger inserted into the pump chamber to reciprocate in a straight line to increase and decrease a capacity in the pump chamber; and
a check valve according to claim 1 and disposed in at least one of a flow path connected to the intake port of the pump chamber and a flow path connected to the discharge port.

4. The solvent delivery pump according to claim 3, wherein the material of the ball seat in the check valve is sapphire.
